(19) United States
(12) Patent Application Publication
(10) Pub. No.: US 2007/0245177 A1
(43) Pub. Date: Oct. 18, 2007

(54) METHOD AND APPARATUS FOR DETERMINING THE TOTAL POWER MARGIN AVAILABLE FOR AN HFC NETWORK

(75) Inventors: Michael J. Cooper, Marietta, GA (US); Charles S. Moore, Langhorne, PA (US); John L. Moran, Uxbridge, MA (US); Robert J. Thompson, Horsham, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/551,014

(22) Filed: Oct. 19, 2006

Related U.S. Application Data
(60) Provisional application No. 60/785,646, filed on Mar. 24, 2006.

(51) Int. Cl. G06F 11/00

(52) U.S. Cl. 714/704

(57) ABSTRACT

The available power margin in a network is determined by increasing the transmission power levels of selected network elements while transmitting a test signal. The quality of the test signal is measured during the successive increases in power level of the selected network elements by measuring the error rate of the test signal. Once the error rate of the test signal reaches a predetermined threshold, the power levels of the signals on the network are determined. The power margin is determined by the difference in the baseline power level on the network and the power level at which the error rate of the test signal exceeded the threshold.

This application claims the benefit of U.S. Provisional Application No. 60/785,646 filed on Mar. 24, 2006, titled “Total Power Margin Test”, herein incorporated by reference in its entirety.

### FIELD OF THE INVENTION

This disclosure is directed toward determining the total power margin available for an HFC network. More particularly, this disclosure is directed toward an automated approach to evaluating the power margin available on network devices.

### BACKGROUND OF THE INVENTION

Coaxial cable television systems have been in widespread use for many years and extensive networks have been developed. The extensive and complex networks are often difficult for a cable operator to manage and monitor. A typical cable network generally contains a headend which is usually connected to several nodes which provide content to a cable modem termination system (CMTS) containing several receivers, each receiver connects to several modems of many subscribers, e.g., a single receiver may be connected to hundreds of modems. In many instances several nodes may serve a particular area of a town or city.

RF devices present in the return path of an HFC network limit the number of services that may be offered and the number of subscribers that may be serviced. That is, the dynamic range of these RF devices limit the amount of power which may be pushed through them. Both the return-path amplifiers and the optical receivers are often a primary cause of these limitations with the optical receiver being the usual weakest link. Both active data services as well as ingress noise consume some of the dynamic range of these RF devices. As a result, there is a finite limit to the number of additional services which may be added to an active network.

Since both the make and manufacturer of these devices and the ingress present on the plant vary, the operator must individually characterize each node of the plant for the available power margin to determine if additional services may be deployed and if so the quantity of additional services. Such a characterization also allows the operator to understand when non-revenue producing power (i.e., ingress) is a dominant factor on the plant and warrants maintenance. Typically, characterization of such power margins of an upstream optical link require a technician or engineer to be at multiple locations within the HFC plant simultaneously with specialized test equipment, such as a vector signal analyzer and signal generators. This manual diagnostic process is labor intensive, time consuming and costly.

### SUMMARY OF THE INVENTION

This disclosure explains an automated process to characterize the total available power margin using terminal devices (such as MTAs or cable modems) in conjunction with measurements made at the headend via a CMTS device, and does not require rolling trucks to remote locations within a plant.

In accordance with principles of the invention, an apparatus for measuring a network may comprise: a receiver configured to receive communications from a first network element at a first frequency f1 and a test signal from test network element at a test frequency ft at the same time, the test signal from the test network element containing testing data; an error monitoring unit which is configured to measure an error rate of the test signal at the frequency ft to provide a measured error rate; and a power monitoring unit which is configured to measure power in communication signals received in the network to provide a measured power.

The apparatus may further comprise a microprocessor configured to determine if the measured error rate exceeds a predetermined error rate.

In the apparatus, if the measured error rate exceeds the predetermined error rate, a power margin may be determined based on the measured power associated with the measured error rate.

In the apparatus, the power margin may be determined based on a difference between an estimated baseline power level in the network and the measured power at the time the measured error rate exceeds the predetermined error rate.

In the apparatus of the invention, the receiver may be configured to receive communications from a second network element at a second frequency f2 at the same time as the first frequency f1 and the test frequency ft.

In the apparatus, the microprocessor may be configured to select a network element as the first network element, another network element as the second network element, and a third network element as the test network element, and to instruct the first network element, the second network element, and the test network element to transmit on the first frequency f1, the second frequency f2, and the test frequency ft, respectively, such that the receiver receives communications from the first network element, the second network element and the test network element at the same time.

In the apparatus of the invention, the first frequency f1 and the second frequency f2 may be selected so that an interaction between f1 and f2 does not produce intermodulation disturbances in the test frequency ft in a transmitting laser in the network.

In the apparatus of the invention, the microprocessor may instruct at least one of the first network element or the second network element to increase a transmission power level if the measured error rate does not exceed a predetermined error rate.

A method for determining power margin in a network in accordance with the present invention may comprise the steps of: selecting a first network element to transmit a first signal at a first frequency f1 and a test network element to transmit a test signal at a test frequency ft; instructing the first network element to transmit a signal at the first frequency to be received at the same time as the test signal at the test frequency; measuring an error rate of the test signal and determining if the measured error rate exceeds a predetermined error rate; measuring a power level of signals on the network when the measured error rate exceeds the predetermined error rate; and determining a power margin in the network based on the measured power level.

The method of the invention may further comprise the step of increasing a transmission power level of the first network element if the measured error rate does not exceed the predetermined error rate.

The method of the invention may further comprise the steps of selecting a second network element to provide transmissions at a second frequency f2 and instructing the second network element to transmit a second signal at the second frequency to be received at the same time as the first signal at the first frequency f1 and the test signal at the test frequency.

In the method of the invention, the first frequency f1 and the second frequency f2 may be selected so that an interaction between f1 and f2 does not produce intermodulation disturbances in the test frequency ft in a transmitting laser in the network.

The method of may further comprise the step of increasing a transmission power level of at least one of the first network element or the second network element if the measured error rate does not exceed the predetermined error rate.

A computer readable medium of the invention may carry instructions for a computer to perform a method for determining power margin in a network, the method may comprise the steps of: selecting a first network element to transmit a first signal at a first frequency f1 and a test network element to transmit a test signal at a test frequency ft; instructing the first network element to transmit a signal at the first frequency to be received at the same time as the test signal at the test frequency; measuring an error rate of the test signal and determining if the measured error rate exceeds a predetermined error rate; measuring a power level of signals on the network when the measured error rate exceeds the predetermined error rate; and determining a power margin in the network based on the measured power level.

In a computer readable medium of the invention, the instructions may further comprise instructions to perform a step of increasing a transmission power level of the first network element if the measured error rate does not exceed the predetermined error rate.

In a computer readable medium of the invention, the instructions may further comprise instructions to perform a step of selecting a second network element to provide transmissions at a second frequency f2 and instructing the second network element to transmit a second signal at the second frequency to be received at the same time as the first signal at the first frequency f1 and the test signal at the test frequency.

In a computer readable medium of the invention, first frequency f1 and the second frequency f2 may be selected so that an interaction between f1 and f2 does not produce intermodulation disturbances in the test frequency ft in a transmitting laser in the network.

In a computer readable medium of the invention, the instructions may further comprise instructions to perform a step of increasing a transmission power level of at least one of the first network element or the second network element if the measured error rate does not exceed the predetermined error rate.

Those of skill in the art will appreciate that the techniques of this invention allows an operator to determine available power margin on a network without the need for placing test instrumentation remotely in the cable plant. In addition, the technique discloses in the invention does not require an operator or technician to be dispatched to remote locations in the HFC network. All measurements may be made through the use of the existing terminal devices (specifically, DOCSIS terminal devices such as MTAs and cable modems) as well as headend equipment (specifically a DOCSIS CMTS). Accurate knowledge of available power margin will enable an operation to utilize the available resources of their network more efficiently, such as by adding additional network elements to portions of the network with a large power margin and shifting network elements away from portions with a small power margin to improve signal quality and network speed.

### BRIEF DESCRIPTION OF THE DRAWINGS

The following drawings serve to illustrate the principles of the invention.

FIG. 1 illustrates an exemplary network in accordance with the principles of the invention.

FIG. 2 illustrates an exemplary CMTS architecture in accordance with the principles of the invention.

FIG. 3 illustrates an exemplary architecture of a network element which may communicate with an exemplary CMTS of the present invention.

FIG. 4 illustrates an exemplary architecture of a headend which may contain an exemplary CMTS of the present invention.

FIG. 5 illustrates an exemplary process in accordance with the principles of the present invention.

FIG. 6 illustrates an intermod impact threshold with respect to a noise floor.

### DETAILED DESCRIPTION OF THE INVENTION

This disclosure provides for a power spectral characterization and the identification of available upstream frequency regions which would support communications. The present invention enables an automatic determination of how much RF power is available in a network for addition of additional services, and ingress power before a predetermined soft failure occurs. A soft failure is a degradation in signal quality which causes pre equalized errors to occur, but are within available limits of error correction, the intent being that there will be no noticeable impairment to the live services on a network. The test in the invention generally involves demodulation of a specified test QAM carrier and measurement of its signal quality to determine impact caused by stressing the network.

The methodology described in this invention instructs two DOCSIS terminal devices (cable modems or MTAs) to transmit simultaneously and measures the affects on a third communications channel, such as the MER (mean error ratio), BER (bit error rate), and PER (packet error rate). Subsequently, power is increased for the two DOCSIS terminal devices until, an impact on the communicating channel is detected. That is, it monitors the affects of increasing power in the return-path of the cable network on an active communications signal and logs the total power added when said power begins to impact the performance of the communications channel. The approach detailed in this disclosure requires that the three DOCSIS terminal devices reside on the same optical node. A methodology for isolating devices which reside on the same optical node is provided in a commonly assigned disclosure Attorney Docket No. BCS04122, entitled METHOD AND APPARATUS FOR GROUPING TERMINAL NETWORK DEVICES filed on Sep. 5, 2006 and assigned U.S. Ser. No. 11/470,034. Preferably, the power margin test should not occur in conjunction with other changes in the network, such as changing of optical routing, ingress level switching or any other routine or event that will likely cause RF levels to be unstable.

Adequate margin should also preferably be available in the network to allow the addition of 2 DOCSIS channels. This margin may be determined by first estimating the total power of the current upstream loading via FFT measurement, then adding a test channel at the same level of the cable modem channel and rerunning the FFT. If total power increase is less than 3 dB with cable modem and test channel loading combined then the system is still functioning in linear region and power addition from test channel is acceptable. Otherwise the optical link may be overdriven. The margin test should be repeated by adding the second test signal. The FFT should also be run with both test signals transmitting at the same time during the second test.

Preferably, an active Return Path is providing services at the time that the operator desires to associate (group) network elements according to common optical nodes. Also, this test picks test frequency locations based upon avoiding interference of 2^{nd} order intermods on active data services. We are assuming adequate margin is available such that 3^{rd} order products are not a problem for the active services. Also, the approach preferably uses DOCSIS cable modems to generate test signals. Therefore test signals will be one of the available DOCSIS bandwidths (200 kHz, 400 kHz, 800 kHz, 1600 kHz, 3200 kHz, 6400 kHz). Preferably, the test will use 800 kHz bandwidth due to narrow bandwidths minimize the amount of clean spectrum required within the return path, and because many modems have problems with the 400 and 200 kHz widths.

FIG. 1 illustrates an exemplary network in which a plurality of terminal network elements 8 (e.g. cable modems, set top boxes, televisions equipped with set top boxes, or any other element on a network such as an HFC network) are connected to a cable modem termination system (CMTS) 10 located in a headend 14 through nodes 12 and one or more taps (not shown). In an exemplary arrangement, headend 14 also contains an optical transceiver 16 which provides optical communications through an optical fiber to the plurality of nodes 12. The CMTS 10 connects to an IP or PSTN network 6. Those of skill in the art will appreciate that there may be a plurality of nodes 12 connected to a headend, and a headend may contain a plurality of CMTS units, each of which contain a plurality of receivers (e.g. 8 receivers) each of which communicate with a plurality (e.g. 100 s) of network elements 8. The CMTS 10 may also contain a spare receiver which is not continuously configured to network elements 8, but may be selectively configured to network elements 8. Use of a spare receiver is described in commonly assigned patent application Ser. No. 11/171066, filed on Jun. 30, 2005 and titled Automated Monitoring of a Network, herein incorporated by reference in its entirety.

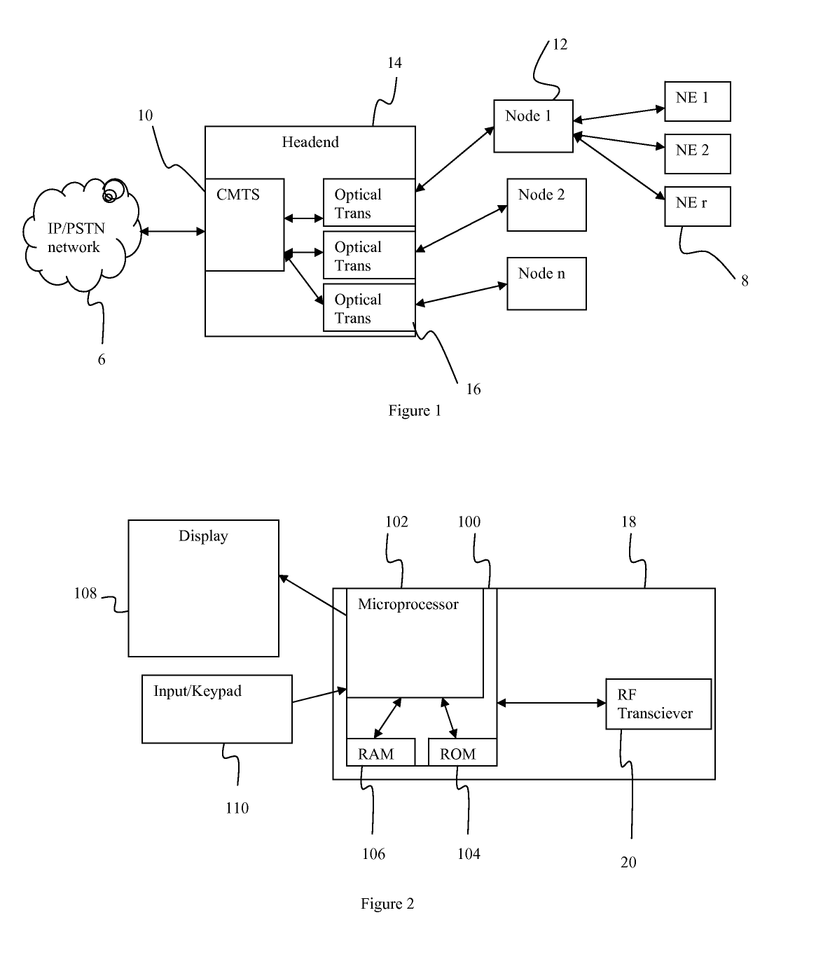

FIG. 2 illustrates a logical architecture of an exemplary CMTS 10. As illustrated in FIG. 2, CMTS 10 may contain a processing unit 100 which may access a RAM 106 and a ROM 104, and may control the operation of the CMTS 10 and RF communication signals to be sent by the network elements 8 to the CMTS. Processing unit 100 preferably contains a microprocessor 102 which may receive information, such as instructions and data, from a ROM 104 or RAM 106. Processing unit 100 is preferably connected to a display 108, such as a CRT or LCD display, which may display status information such as whether a station maintenance (SM) is being performed or an unregistered receiver is eligible for load balancing. An input keypad 110 may also be connected to processing unit 100 and may allow an operator to provide instructions, processing requests and/or data to processor 100.

A RF transceiver (transmitter/receiver) 20 preferably provides bi-directional communication with a plurality of network elements 8 through optical transceivers 16, nodes 12 and a plurality of network taps (not shown). Those of skill in the art will appreciate that CMTS 10 may contain a plurality of RF transceivers, e.g. 8 RF transceivers and a spare RF transceiver. Each RF transceiver may support over 100 network elements. RF transceiver 20, such as a Broadcom 3140 receiver (transceiver), is preferably used to acquire equalizer values and burst mean error ratio (MER) measurements, packet error rate (PER) and bit error rate (BER). RF transceiver 20 may also include FFT module 308 to support power measurements. The communication characteristics of each receiver 20 may be stored on ROM 104 or RAM 106, or may be provided from an external source, such as headend 14. RAM 104 and/or ROM 106 may also carry instructions for microprocessor 102.

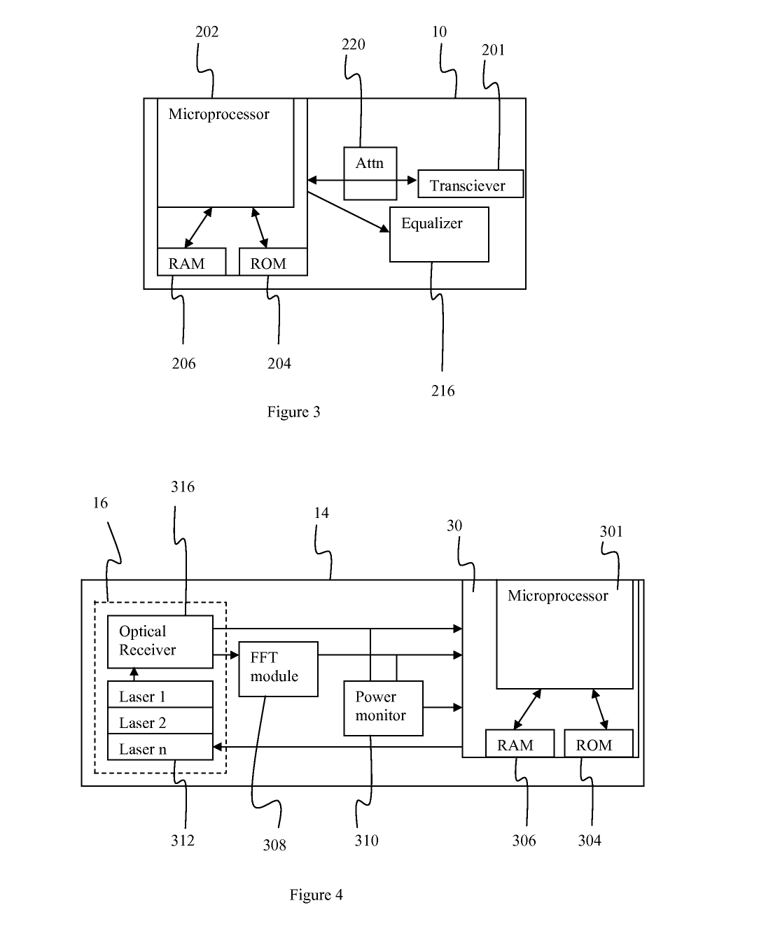

FIG. 3 illustrates an exemplary network element 8, such as a cable modem. Network element 8 preferably contains a processor 202 which may communicate with a RAM 206 and ROM 204, and which controls the general operation of the network element, including the pre-equalization parameters and preamble lengths of communications sent by the network element in accordance with instructions from the CMTS 10. Network element 8 also contains a transceiver (which includes a transmitter and receiver) which provides bidirectional RF communication with CMTS 10. Network element 10 may also contain an equalizer unit which may equalize the communications to CMTS 10. Network element 10 may also contain an attenuator 220 which may be controlled by microprocessor to attenuate signals to be transmitted to be within a desired power level. Those of skill in the art will appreciate that the components of network element 8 have been illustrated separately only for discussion purposes and that various components may be combined in practice.

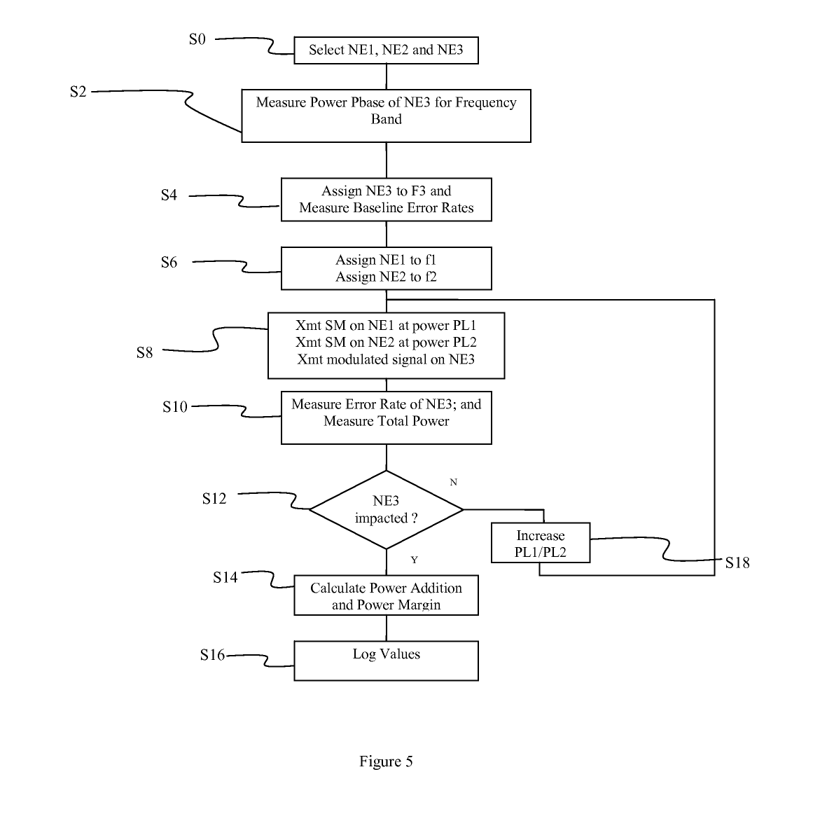

FIG. 4 illustrates further detail of an exemplary headend 14. Headend 14 preferably contains an optical transceiver 16 which preferably includes an optical receiver 316 configured to receive optical signals through an optical fiber from nodes 12. A plurality of laser transmitters 312 provide downstream optical communications to nodes 12 through an optical fiber. A laser transmitter may be assigned to communicate with a single node. A fast Fourier transform (FFT) module 308 such as a Broadcom 3140 receiver FFT, identifies frequencies in the optical signals received and provides desired frequencies to power monitoring unit 310. Preferably, the FFT supports different windows, and sample lengths (256, 512, 1024, 2048) with an output of frequency of 0-81.92 MHz. Minimum resolution results from maximum window length of 2048 samples and yields an FFT cell resolution of 80 kHz. CPU 30 preferably contains a microprocessor 301 which interacts with RAM 306 and ROM 304 and controls the operation of the headend unit and preferably implements the method illustrated in FIG. 5.

Upon receiving a downstream communication signal from a network element, via CMTS 10, CPU 30 preferably provides instructions to modulate one of the laser transmitters 312 to transmit the communication signal to nodes 12. Optical receivers 316 are preferably configured to monitor the optical signal transmitted by nodes 12, such as by receiving a portion of the signal. Optical receiver 316 preferably provides the monitored portion to the FFT module 308 where intermods may be determined and power monitor unit 310 where the power level in a specific frequency (such as the test frequency) may be measured or the total power of the signal may be measured.

An exemplary process for automatically determining the power margin available in the system on an optical node is illustrated in FIG. 5. As illustrated in step S0 of FIG. 5, three network elements NE1, NE2 and NE3 are selected for to be used by two network elements in the process. Preferably, the three modems are connected to the same HFC node and return laser, are currently idle, have sufficient ability to have their transmit power turned up by (15) dB, and can be controlled remotely by the CMTS to move to new frequencies at command and change their transmission power level. Also in a preferred implementation, one of these selected network elements will be used to provide a modulated signal, such as a 16 QAM, 2.56 Msym/sec, which is used as the “test signal” for the power margin test. The other two network elements will be instructed to transmit on a channel which impacts the test signal, such as 800 kHz QPSK channels, whose power is increased sufficiently to cause loading (compression) of the RF devices (most likely the return laser transmitter) in the system.

Ideally, we want to find two frequencies that network elements NE1 and NE2 could transmit on which would not produce a 2^{nd} order intermod at a third frequency to which network element NE3 may be assigned. Each of the three frequencies are preferably within the 5-42 MHz spectrum. The possible frequencies may be identified by a plurality of techniques, such as by empirically determining usable frequency regions for QPSK (quadrature phase shift keying, also referred to as four QAM) transmission from a survey process. The communication frequencies (f₁ and f₂) are preferably selected such that f1±f2 does not fall on f3 and each of f1, f2 and f3 lies between 5-42 MHz. The three frequencies are also preferably selected such that second order products from these frequencies do not fall on desired traffic in the network, if possible. Preferably, frequencies f1 and f2 can be activated as DOCSIS upstream channels with default upstream CMTS receive levels without causing any significant harm to any other active services.

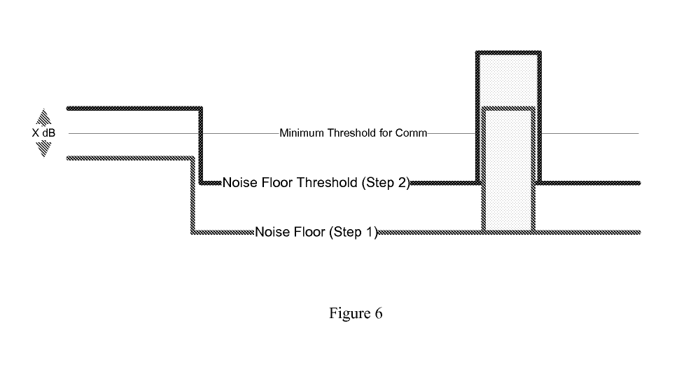

As illustrated in FIG. 5, the power of the frequency band, e.g. 5-42 MHz is measured, step S2. This measurement provides a reference baseline power of the frequency band, as illustrated in FIG. 6. In a preferred implementation, this measurement may be performed as an incremental power measurement of the band of interest (5-42) MHz and may be recorded showing amplitude vs. frequency for at least 10 times showing occupied frequency bands and periodicity of channels on the network. An estimation of the total network RF power vs. single channel power is may also be mathematically estimated from measured data.

As illustrated in step S4 of FIG. 5, network element 3 is assigned to frequency f3, which is used as the test frequency F(t), and the baseline error rates, such as MER, PER and BER are measured. The error rate may be measured at the CMTS by measuring the MER, PER and BER, such as by using an equalizer contained in the CMTS, not shown. The total power may be measured at the CMTS, for example by measuring the received RF power at FFT module 308 and Power monitor module 301. Alternatively, power may be determined from the settings on attenuator 220 of network element 3.

As illustrated in step S6 of FIG. 5, network element 1 is assigned to frequency f1 and network element 2 is assigned to frequency f2. Network elements 1 and 2 are instructed to simultaneously transmit at a predetermined power level PL1 and PL2, respectively, while network element 3 transmits the modulated test signal, step S8. The error rate of the modulated test signal from network element 3 is measured and the total power of the frequency spectrum, e.g. 5-42 MHz is measured again. The error rate may be measured at the CMTS by measuring the MER, PER and BER, such as by using an equalizer contained in the CMTS, not shown. The total power may be measured at the CMTS, for example by measuring the received RF power at FFT module 308 and Power monitor module 301. Alternatively, power may be determined from the settings on attenuator 220 of network element 3.

PL1 and PL2 may be the same power level and may be at level L which was assigned as the nominal power level. In this step, network elements 1 and 2 are preferably instructed to perform a station maintenance (SM) burst at exactly the same time. Those of skill in the art will appreciate that this may be done by lining up the minislots in the MAPS for the two upstream channels associated with network elements A and B. Those of skill in the art will also appreciate that the MAP or MAPS data provide a schedule of time slots which allocates different network elements specific time intervals in which they are allowed to transmit data to the CMTS. From a CMTS software perspective, this should not be a complicated problem as the IM broadcast intervals are already aligned across ALL channels within a single spectrum group. The FFT processor should also be configured to trigger samples based upon the MAP minislot interval when the two SM bursts from the network elements will align. The combined power (Pc) and the power of f3 (Pf3) are measured, as illustrated in step S10. It may be desirable to perform steps S8 and S10 several times to eliminate the possibility that a coincidental ingress happened at the exact same instance as the SM bursts.

The CMTS spare receiver may be used to make the error rate and power measurements to avoid impacting service provided to customers,. Alternatively, another receiver could be used to make the measurements by being taken “off line” or by adjusting for the impact caused by normal service.

If the simultaneous transmission has not increased the power level in the FFT cell at the test frequency (f₃) to significantly impact the test signal, step S12, NO, then in step S18, then the power level of network element 1 or 2 or both is increased and the process in steps S8 and beyond is repeated. If the test signal from network element 3 is impacted, step S12 YES, the power addition and power margin are calculated, step S14 and logged in step S16.

The MER, PER and/or BER is measured at each incremental increase in power level and signals are increased until degradation in MER and more importantly a significant increase in PER is noted. The cause of this impairment is loading (compression) of the RF devices (most likely the return laser transmitter) in the system from the power created by the transmissions of network elements 1 and 2.

The processes in FIG. 5 may be implemented in hard wired devices, firmware or software running in a processor. A processing unit for a software or firmware implementation is preferably contained in the CMTS. Any of the processes illustrated in FIG. 5 may be contained on a computer readable medium which may be read by microprocessor 301. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

The invention enables the technician or engineer to remotely characterize upstream total power margin quickly at a central location, such as the headened such as by using the Motorola BSR64000, rather than having to use external test equipment, such as the vector signal analyzer and deploying technicians to various locations within the cable plant without impacting active services. It also allows the MSO to plan for future offerings and schedule needed maintenance by allowing him/her to periodically monitor this power margin. All measurements may be made through the use of the existing terminal devices (specifically, DOCSIS terminal devices such as MTAs and cable modems) as well as headend equipment (specifically a DOCSIS CMTS).

Those of skill in the art will appreciate that the techniques of this invention allows an operator to determine available power margin on a network without the need for placing test instrumentation remotely in the cable plant. In addition, the technique discloses in the invention does not require an operator or technician to be dispatched to remote locations in the HFC network. All measurements may be made through the use of the existing terminal devices (specifically, DOCSIS terminal devices such as MTAs and cable modems) as well as headend equipment (specifically a DOCSIS CMTS). Accurate knowledge of available power margin will enable an operation to utilize the available resources of their network more efficiently, such as by adding additional network elements to portions of the network with a large power margin and shifting network elements away from portions with a small power margin to improve signal quality and network speed.

What is claimed is:

1. An apparatus for measuring a network comprising:
a receiver configured to receive communications from a first network element at a first frequency f1 and a test signal from test network element at a test frequency ft at the same time, the test signal from the test network element containing testing data;
an error monitoring unit which is configured to measure an error rate of the test signal at the frequency ft to provide a measured error rate; and
a power monitoring unit which is configured to measure power in communication signals received in the network to provide a measured power.

2. The apparatus of claim 1, further comprising a microprocessor configured to determine if the measured error rate exceeds a predetermined error rate.

3. The apparatus of claim 2, wherein if the measured error rate exceeds the predetermined error rate, a power margin is determined based on the measured power associated with the measured error rate.

4. The apparatus of claim 3, wherein the power margin is determined based on a difference between an estimated baseline power level in the network and the measured power at the time the measured error rate exceeds the predetermined error rate.

5. The apparatus of claim 2, wherein the receiver is configured to receive communications from a second network element at a second frequency f2 at the same time as the first frequency f1 and the test frequency ft.

6. The apparatus of claim 5, wherein the microprocessor is configured to select a network element as the first network element, another network element as the second network element, and a third network element as the test network element, and to instruct the first network element, the second network element, and the test network element to transmit on the first frequency f1, the second frequency f2, and the test frequency ft such that the receiver receives communications from the first network element, the second network element and the test network element at the same time.

7. The apparatus of claim 6, wherein the first frequency f1 and the second frequency f2 are selected so that an interaction between f1 and f2 does not produce intermodulation disturbances in the test frequency ft in a transmitting laser in the network.

8. The apparatus of claim 6, wherein the microprocessor instructs at least one of the first network element or the second network element to increase a transmission power level if the measured error rate does not exceed a predetermined error rate.

9. A method for determining power margin in a network comprising the steps of:
selecting a first network element to transmit a first signal at a first frequency f1 and a test network element to transmit a test signal at a test frequency ft;
instructing the first network element to transmit a signal at the first frequency to be received at the same time as the test signal at the test frequency;
measuring an error rate of the test signal and determining if the measured error rate exceeds a predetermined error rate;
measuring a power level of signals on the network when the measured error rate exceeds the predetermined error rate; and
determining a power margin in the network based on the measured power level.

10. The method of claim 9, further comprising the step of increasing a transmission power level of the first network element if the measured error rate does not exceed the predetermined error rate.

11. The method of claim 9, further comprising the steps of selecting a second network element to provide transmissions at a second frequency f2 and instructing the second network element to transmit a second signal at the second frequency to be received at the same time as the first signal at the first frequency f1 and the test signal at the test frequency.

12. The method of claim 11, wherein the first frequency f1 and the second frequency f2 are selected so that an interaction between f1 and f2 does not produce intermodulation disturbances in the test frequency ft in a transmitting laser in the network.

13. The method of claim 11, further comprising the step of increasing a transmission power level of at least one of the first network element or the second network element if the measured error rate does not exceed the predetermined error rate.

14. A computer readable medium carrying instructions for a computer to perform a method for determining power margin in a network, the method comprising the steps of:
selecting a first network element to transmit a first signal at a first frequency f1 and a test network element to transmit a test signal at a test frequency ft;
instructing the first network element to transmit a signal at the first frequency to be received at the same time as the test signal at the test frequency;
measuring an error rate of the test signal and determining if the measured error rate exceeds a predetermined error rate;
measuring a power level of signals on the network when the measured error rate exceeds the predetermined error rate; and
determining a power margin in the network based on the measured power level.

15. The computer readable medium of claim 14, wherein the instructions further comprise instructions to perform a step of increasing a transmission power level of the first network element if the measured error rate does not exceed the predetermined error rate.

16. The computer readable medium of claim 14, wherein the instructions further comprise instructions to perform a step of selecting a second network element to provide transmissions at a second frequency f2 and instructing the second network element to transmit a second signal at the second frequency to be received at the same time as the first signal at the first frequency f1 and the test signal at the test frequency.

17. The computer readable medium of claim 16, wherein the first frequency f1 and the second frequency f2 are selected so that an interaction between f1 and f2 does not produce intermodulation disturbances in the test frequency ft in a transmitting laser in the network.

18. The computer readable medium of claim 16, wherein the instructions further comprise instructions to perform a step of increasing a transmission power level of at least one of the first network element or the second network element if the measured error rate does not exceed the predetermined error rate.
